(19) United States
(12) Patent Application Publication
(10) Pub. No.: US 2007/0002481 A1
(43) Pub. Date: Jan. 4, 2007

(54) Magnetic recording apparatus

(75) Inventors: Akira Kikitsu, Yokohama-shi (JP); Masatoshi Sakurai, Tokyo (JP); Masahiro Oka, Ichihara-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); SHOWA DENKO K.K., Tokyo (JP)

(21) Appl. No.: 11/475,863

(22) Filed: Jun. 28, 2006

(30) Foreign Application Priority Data
Jun. 28, 2005 (JP) 2005-188385

(51) Int. Cl. G11B 5/09

(52) U.S. Cl. 360/48

(57) ABSTRACT

According to one embodiment, a magnetic recording apparatus has a magnetic recording media including a substrate having protrusions and recesses corresponding to a servo zone and a data zone and a magnetic layer deposited thereon, and a read/write head including a pair of magnetic shields and a giant magnetoresistive element, in which a track pitch of the media ranges 20 to 300 nm, a linear velocity of the magnetic recording media is 11 m/s, and a distance m from the magnetic shield to the magnetic layer on the protrusions of the media and a distance d between the magnetic layer on the protrusions and that on the recesses in the servo zone of the media are satisfies the condition that the value of d/m is 0.2 or more and 3 or less.

### CROSS-REFERENCE TO RELATED APPLICATIONS

This application is based upon and claims the benefit of priority from Japanese Patent Application No. 2005-188385, filed Jun. 28, 2005, the entire contents of which are incorporated herein by reference.

### BACKGROUND

1. Field

One embodiment of the invention relates to a magnetic recording apparatus comprising patterned media of substrate processing type.

2. Description of the Related Art

A patterned media having a configuration corresponding to servo signals and tracks or data bits has been studied as a high-density magnetic recording media. In particular, a patterned media manufactured with a method comprising processing a substrate into the aforementioned configuration and depositing a multilayered film including a magnetic film using a conventional process (referred to as a substrate processing type hereinafter) has an advantage of small additional fabrication cost because of simple process. On the other hand, there has been proposed a patterned media manufactured with a method comprising depositing a multilayered film including a magnetic film on a flat substrate and processing the magnetic film by etching or the like (referred to as a magnetic layer processing type). Although there is an advantage that conventional processes can be applied in this process until the etching step, there are concerns about degradation of magnetic characteristics and dust generation when fine processing of the magnetic layer is carried out.

A patterned media of substrate processing type has been studied long before (see Jpn. Pat. Appln. KOKAI Publication Nos. 9-282648 and 2000-293843).

Jpn. Pat. Appln. KOKAI Publication No. 9-282648 discloses a technique of compensating for insufficient intensity of servo signals, in a magnetic disk having data zones and servo zones in the form of protrusions and recesses, by setting a flying height of a head slider over the servo zone less than that over the data zone and setting it more than the glide height. The document describes that the depth of recesses on the substrate, the flying height, and linear velocity are 200 nm, 50 nm, and 7 m/s, respectively. The document also describes that the shortest wavelength of servo signals is 1.6 μm, it is deduced that the track pitch will be 1 μm to several μm.

Jpn. Pat. Appln. KOKAI Publication No. 2000-293843 discloses a technique of suppressing fluctuation in flying height of the magnetic head in a magnetic disk having data zones and servo zones in the form of protrusions and recesses by setting the relationship between the groove width L and the groove depth W of recesses in the servo zone to meet the following formula: L/W<0.8.

For the purpose of developing a high-density magnetic recording apparatus, the present inventors tried to fabricate a magnetic recording apparatus in accordance with the above mentioned techniques using a patterned media having a track pitch of 300 nm, which is smaller by one order as compared with the above mentioned patterned media. As a result, it was found that a signal-to-noise ratio (SNR) of servo signals is too low to be used for the tracking operation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a magnetic recording media in a magnetic recording apparatus according to an embodiment of the present invention;

FIG. 2 is a plan view showing an example of a magnetic recording media in a magnetic recording apparatus according to an embodiment of the present invention;

FIG. 3 is a plan view showing another example of a magnetic recording media in a magnetic recording apparatus according to an embodiment of the present invention;

FIG. 4 is a sectional view showing a magnetic recording media in a magnetic recording apparatus according to an embodiment of the present invention;

FIG. 5 is a sectional view showing a read element (sensor) of a read/write head in a magnetic recording apparatus according to an embodiment of the present invention;

FIG. 6 is a perspective view showing a magnetic recording apparatus according to an embodiment of the present invention;

FIG. 7 is a sectional view schematically showing a position of a magnetic recording media and a read/write head in a magnetic recording apparatus according to an embodiment of the present invention;

FIG. 8 is a sectional view schematically showing a position of a magnetic recording media and a read/write head in a magnetic recording apparatus according to an embodiment of the present invention; and

FIG. 9 is a plan view schematically showing a position of a magnetic layer on protrusions of a magnetic recording media and one of the magnetic shields in a magnetic recording apparatus according to an embodiment of the present invention.

### DETAILED DESCRIPTION

Various embodiments according to the invention will be described hereinafter with reference to the accompanying drawings. In general, according to one embodiment of the present invention, there is provided a magnetic recording apparatus comprising: a magnetic recording media comprising: a substrate on which patterns of protrusions and recesses corresponding to a servo zone and a data zone are formed, and a magnetic layer deposited on the substrate; a spindle motor which rotates the magnetic recording media; and a read/write head mounted on a slider and being positioned in flying over the magnetic recording media, the read/write head including a pair of magnetic shields and a giant magnetoresistive element between the magnetic shields, the track pitch in the data zone of the magnetic recording media is 20 nm or more and 300 nm or less, a relative linear velocity between the read/write head and the magnetic recording media is 11 m/s or less, and, when a distance from the magnetic shield of the read/write head to the magnetic layer on the protrusions of the magnetic recording media is defined as “m” and a distance between the magnetic layer on the protrusions and that deposited on the recesses in the servo zone of the magnetic recording media is defined as “d”, a ratio of d/m is 0.2 or more and 3 or less.

The present inventors investigated in detail the cause of the reduction in the SNR of the substrate processing type patterned media fabricated at a high track pitch, as described above. As a result, it was found that noise in the servo signals become large, depending on a distance between the magnetic layer on the protrusions and the magnetic layer on the recesses of the media. It is deduced that the noise is generated by an unstable magnetization structure inside the magnetic shields of the head in reading servo signals.

In the case of the aforementioned prior art of the patterned media, it is deduced that such noise has not been generated because the head is probably an inductive ring head that does not have shields, although there is no description on the head structure. Another possible reason is that a change in signal intensity at an edge of the patterned media is small under such a large track pitch.

A magnetic recording apparatus according to an embodiment of the present invention achieves a good tracking operation while suppressing degradation of SNR of servo signals by properly setting a track pitch in the data zone of the magnetic recording media, a relative linear velocity between the read/write head and the magnetic recording media, and a ratio of d/m of a distance “m” from the magnetic shield of the read/write head to the magnetic layer deposited on the protrusions of the magnetic recording media and a distance “d” between the magnetic layer deposited on the protrusions and that deposited on the recesses in the servo zone of the magnetic recording media.

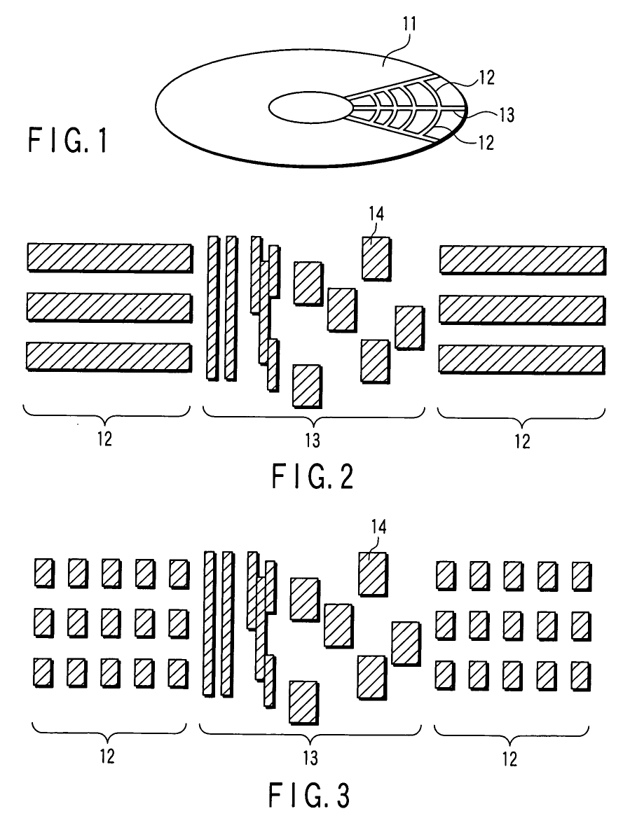

FIG. 1 is a perspective view schematically showing a patterned media. On a surface of the magnetic recording media (patterned media) 11, there exist servo zones 13 including burst signals, addresses, and preambles or the like for tracking and data access control and data zones 12 where user data are written. FIG. 1 schematically depicts arrangement of these zones on the disk surface in the form of lines.

FIG. 2 is an enlarged plan view showing an example of a data zone and a servo zone in the patterned media shown in FIG. 1. In the servo zone 13 shown in FIG. 2, patterns of a magnetic layer on the protrusions of a substrate which has been patterned to form protrusions and recesses correspond to servo patterns used in a current magnetic recording media. The servo zone 13 includes burst signals 14 for tracking control, for example. In the data zone 12 shown in FIG. 2, track patterns made of a magnetic layer are formed continuously in a circumferential direction separated by the recesses. The patterned media of this type is also referred to as a discrete track media.

FIG. 3 is an enlarged plan view showing another example of the data zone and the servo zone in the patterned media shown in FIG. 1. In the data zone 12 shown in FIG. 3, data bits made of a magnetic layer are separated by the recesses. The media of this type is a patterned media in a narrow sense.

In the discrete track media shown in FIG. 2, linear recording density is determined depending on magnetization transition width formed on the tracks by the similar mechanism to that in the current magnetic recording media. In the patterned media in a narrow sense shown in FIG. 3, the linear recording density is determined by the processed patterns of data bits. The patterned media in FIG. 3, as compared with that in FIG. 2, has an advantage of high-density recording but has difficulties in fabrication process and head access control. The present invention can be applied to both types shown in FIGS. 2 and 3.

Thus, the present invention attains an advantageous effect of noise reduction in reading servo signals from steps formed on the substrate as described later. Therefore, the present invention can also be applied to phase difference servo or any other servo system without being restricted to the ABCD burst, although FIG. 2 illustrates ABCD burst signals by way of example. That is, the present invention can be applied to any kind of patterned media providing servo signals from the patterns on the substrate.

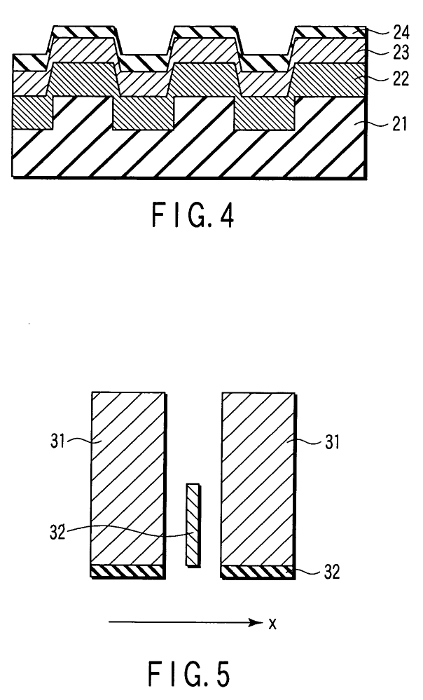

FIG. 4 is a sectional view of a patterned media. The substrate 21 is processed to have patterns of protrusions and recesses corresponding to servo zones and data zones. On this substrate 21, the underlayer 22, the magnetic recording layer 23 made of a magnetic layer and the protective layer 24 are formed. In order to flatten the surface of the magnetic recording media, a nonmagnetic material may be filled in the recesses.

To form the patterns of protrusions and recesses on the substrate, an etching process is applied using a mask with a desired pattern, as in a semiconductor manufacturing process, so as to transfer the mask pattern into protrusions and recesses. Also, a so-called imprint method, in which a soft mask material is coated on a flat substrate and a master plate having a desired pattern is pressed onto the mask material to form a processing mask, may be used. Mask materials used for imprinting process include a photocuring resin, SOG (spin-on-glass), alumina fine particles and the like. A method, in which a resist is coated on the substrate and then patterns are directly written with a high-energy beam such as an electron-beam to form a mask, may be used.

FIG. 5 is a sectional view showing a read head. The read head includes a pair of magnetic shields 31 and a giant magnetoresistive element (GMR element) 33 serving as a read element between the magnetic shields 31. A protective film 32 is formed on the air-bearing surface (ABS) of the magnetic shield 31. The read/write head is mounted on a slider, and is positioned in flying over the magnetic recording media. The x direction indicated by the arrow shown in FIG. 5 is a head traveling direction (down-track direction).

The magnetic shields 31 may be made of a material that is generally used for those in a current magnetic recording apparatus. The magnetic shields 31 may be made of a soft magnetic material similar to that used for a soft magnetic underlayer (SUL) in the perpendicular magnetic recording media. It is preferable that the soft magnetic material used for the magnetic shields 31 should have higher permeability, small coercivity, and high saturation magnetization, compared with SUL. In order to obtain efficient read-out signal, the magnetic shields should preferable have a high permeability at high frequency regions so as to detect a very weak leakage magnetic field from the magnetic recording media at high-speed operation. The protective film 32 may be made of a material similar to that for the protective film 24 of the media.

A read element (sensor) can be one used in a conventional magnetic recording apparatus. In an existing product, a multi-layered film having structure of a magnetic material/a metal spacer layer/a magnetic material called a giant magnetoresistive element (GMR element) is generally used as the read element. Further, a tunneling magnetoresistive element (TMR element) and an advanced GMR element such as a current-perpendicular-to-plane type, a nano-oxide layer (NOL) insertion type and a current-confined-path type may be used. In the present invention, a type of the read element is not limited in particular. Although no protective film is provided for the GMR element 33 in FIG. 5, a protective film may be provided on the air-bearing surface of the GMR element 33. The GMR element 33 may be recessed from the air-bearing surface of the head.

In FIG. 5, for the purpose of convenience, input/output leads for electrical signals to/from the read element (sensor) or a write head and the like are omitted. However, those components used in a current magnetic recording apparatus can be used in the present invention.

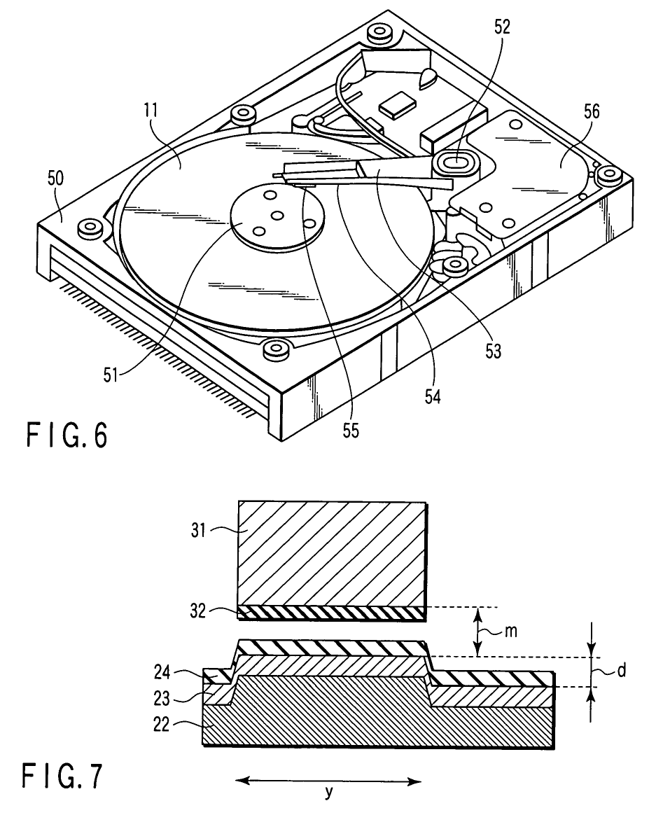

FIG. 6 is a perspective view showing a magnetic recording apparatus according to an embodiment of the present invention. The magnetic recording apparatus comprises, inside the chassis 50, a magnetic recording media 11, a spindle motor 51 for rotating the magnetic recording media 11, a head slider 55 including a read head which uses a giant magnetoresistive element, a head suspension assembly (suspension 54 and actuator arm 53) for supporting the head slider 55, a voice coil motor (VCM) 56, and a circuit board.

The magnetic recording media 11 is mounted on the spindle motor 51 and is rotated, and a variety of digital data are recorded in accordance with a perpendicular or longitudinal magnetic recording system. A magnetic head incorporated in the head slider 55 is of a so-called integrated type. As a write head, a single pole head is used in the case of perpendicular magnetic recording, and a ring head is used in the case of longitudinal magnetic recording. A write head other than the above types may be used. As a read head, aforementioned GMR element, or a TMR element or an element of any other type may be used. The read head has a pair of magnetic shields that sandwich the read element.

The suspension 54 is held at one end of the actuator arm 53, and the head slider 55 is supported so as to face to the recording surface of the magnetic recording media 11 by means of the suspension 54. The actuator arm 53 is attached to a pivot 52. At the other end of the actuator arm 53, the voice coil motor (VCM) 56 is provided as an actuator. The head suspension assembly is driven by means of the voice coil motor (VCM) 56, and a magnetic head is positioned over an arbitrary radial position of the magnetic recording media 11. The circuit board comprises a head IC, and generates drive signals for the voice coil motor (VCM) and control signals for controlling read/write operations by the magnetic head.

In the magnetic recording apparatus according to an embodiment of the present invention, the track pitch in the data zone of the magnetic recording media is 20 nm or more and 300 nm or less, the relative linear velocity between the read/write head and the magnetic recording media is 11 m/s or less, and, when a distance from the magnetic shield of the read/write head to the magnetic layer on the protrusions of the magnetic recording media is defined as “m” and a distance between the magnetic layer on the protrusions and that on the recesses in the servo zone of the magnetic recording media is defined as “d”, the ratio of d/m is 0.2 or more and 3 or less.

FIG. 7 is a sectional view schematically showing an arrangement of a magnetic recording media and a read/write head in the magnetic recording apparatus according to an embodiment of the present invention. This figure shows a state in which magnetic shields 31 of the read head are positioned over a protrusion in the servo zone of the magnetic recording media. A head traveling direction is that direction perpendicular to the plane of the drawing paper sheet. The “y” direction indicated by the arrow in FIG. 7 is defined as the radial direction of the disk, i.e., the cross-track direction. The symbol “m” denotes a distance from the lower end of the magnetic shield 31 to the magnetic layer 23 on the protrusion of the magnetic recording media. It should be noted that the thickness of the protective film 32 of the magnetic shield 31 and the thickness of the protective film 24 of the magnetic recording media are ignored. The distance “m” is also referred to as magnetic spacing. A symbol “d” denotes a distance between the magnetic layer on the protrusion and the magnetic layer on the recess in the servo zone. The distance “d” is approximately equal to the depth of recesses of an etched substrate. However, the distance “d” is not always with the same as the depth of recesses, but it depends on the state of deposition of the underlayer or intermediate layer.

As described above, a magnetic recording media of substrate processing type has been studied so far. The present inventors carried out experiments with respect to the discrete track media and the patterned media of substrate processing type with a track pitch of 500 nm or less. They found that there is a problem which cannot be successfully solved by the prior art. The problem is that, in a case where a relative linear velocity between a read/write head and a magnetic recording media is 11 m/s or less and the track pitch in the data zone of the magnetic recording media is 300 nm or less, nonlinear noise appeared in servo signals and it makes impossible to perform proper servo operation. They found that the noise becomes more significant under environmental tests such as applying an external magnetic field or raising the temperature. This noise problem is not good for an actual product.

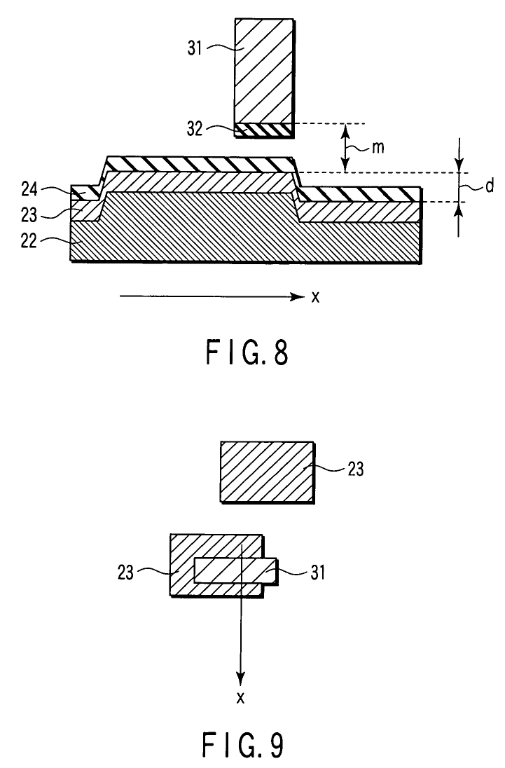

As a result of detailed investigation, it has been estimated that the noise is attributed to the causes described hereafter. FIG. 8 is a sectional view schematically showing position of the magnetic recording media and the read/write head. The “x” direction indicated by the arrow in FIG. 8 is the head traveling direction (down-track direction). FIG. 9 is a plan view schematically showing a position of the magnetic layer on the protrusion of the magnetic recording media and the one end of the magnetic shield pair 31.

As shown in FIG. 8, a magnetic field which is sensed by the GMR element when the magnetic shield 31 of the read head passes over a servo zone depends on change in distance between the magnetic shield 31 and the magnetic layer 23 below the shield, i.e., change in combination of “m” and “d”. In high density recording, since the track pitch become small, the window area of the shield (area of the portion designated by the reference number 31 shown in FIG. 9), which detects a leakage magnetic field from the magnetic recording media, is reduced. At the edge of the magnetic shield 31, magnetic characteristics tend to be degraded due to defects or the like. It is known that a magnetization (magnetic domain wall) is likely to be pinned there and lead to a poor response of the magnetic field. In addition, the reduction in the volume of the magnetic shield 31 is likely to cause thermal fluctuation problem. If the ratio of d/m is large under such a situation, the change in a magnetic field (magnetic flux) in the shield becomes large and it generates unstable movement of magnetization due to a deviation in the local magnetic characteristics at the edge of the shield. The present inventors have deduced that such magnetization movement can cause noise. Then, the present inventors fabricated media with various ratios of d/m and examined their effect. As a result, it was found that in the case where the ratio d/m ranges between 0.2 and 3, the noise can be reduced. By setting the ratio d/m to the range of between 0.25 and 2, an advantageous effect of further noise reduction is attained. The value of d/m is determined depending on the specification of an apparatus, and is not limited by the example of the present invention.

Further, in the case where the relative linear velocity between the read/write head and the magnetic recording media is higher than 11 m/s, noise was not large within the range of examination. It seems that a change in magnetic flux is so fast that the response of the magnetization is delayed inside the magnetic shield and results in a suppression of the unstable local magnetization structure. However, a clear reason remains unidentified. When the noise characteristics were investigated similarly with media having different track pitches, no such an unstable noise was observed in the case where the track pitch was 300 nm or more.

As a result of checking an allowance of the linear velocity and track pitch, it has been found that, when the linear velocity is 11 m/s or less and the track pitch of the magnetic recording media is within the range of 50 nm to 300 nm, there was successfully attained an advantageous effect of suppressing noise generation by defining the ratio d/m in the range of 0.2 to 3. When the ratio d/m is 0.2 or less, sufficient signal intensity cannot be obtained. Since a media having a track pitch of 50 nm or less has not been examined, an advantageous effect of the present invention has not been verified, though the effect is expected.

An advantageous effect of the present invention can be attained in a longitudinal magnetic recording media, in which an easy axis of magnetization is oriented to in-plane direction, or in a perpendicular magnetic recording media, in which the easy axis of magnetization is oriented to the perpendicular direction to the media. Since the servo signals are similarly provided by converting change in leakage magnetic field produced in the shield into signals even in longitudinal recording or in perpendicular recording, the similar effect is attained by the present invention.

### EXAMPLES

### Example 1

Discrete track media having a planer structure shown in FIGS. 1 or 2 and a sectional structure shown in FIG. 4 were fabricated.

First, a master plate serving as a template for the patterns of the discrete track media was fabricated. A photosensitive resin was coated on a Si substrate, and then electron-beam is exposed to form the latent images. An electron beam exposure apparatus comprising a signal source for irradiating the electron beam at a predetermined timing and a stage for moving the substrate with high precision synchronized with the signal source was used for this process. Patterns with five types of track pitches (Tp) of 50 nm, 120 nm, 200 nm, 300 nm, and 400 nm were formed on the same master plate. By developing the latent images, patterns of protrusions and recesses were formed.

On this resist master plate, a Ni conductive film was formed by conventional sputtering. Next, a nickel film with a thickness of about 300 μm was electroplated on the conductive film. High-concentration nickel sulfamate plating solution (NS-160) available from Showa Chemical Co., Ltd was used for the electroplating. The electroforming conditions were as follows:

Nickel sulfamate: 600 g/L;

Boric acid: 40 g/L;

Surfactant (sodium lauryl sulfate): 0.15 g/L,

Solution temperature: 55° C.;

pH: 3.8 to 4.0; and

Current density: 20A/dm².

Then, the electroformed film was stripped from the resist master plate, whereby a stamper comprising the conductive film, electroformed film, and resist residue was obtained. Next, the resist residue was removed by oxygen plasma ashing process. The oxygen plasma ashing was carried out by introducing oxygen at 100 ml/min to adjust the pressure to 4 Pa in the chamber, and then igniting plasma at 100 W for 10 minutes.

The obtained stamper was a father stamper. The father stamper itself can be used as a stamper for use in a succeeding imprinting process. However, stampers were duplicated by repeating the aforementioned electroforming process to the father stamper. First, an oxide film was formed on the surface of the father stamper by oxygen plasma ashing process similar to the step of removing the resist residue. An oxygen gas was introduced at 100 ml/min to adjust the pressure to 4 Pa in the chamber, and then the father stamper was subjected in the plasma under 200 W for 3 minutes. Then, a nickel film was electroformed in accordance with the process as previously described. Then, the electroformed film was stripped from the father stamper to obtain a mother stamper, which was a reversed template of the father stamper. 10 or more mother stampers with the same configuration were obtained by repeating the steps of obtaining the mother stamper from the father stamper.

Subsequently, similarly as the step of obtaining a mother stamper from a father stamper, an oxide film was formed on the surface of the mother stamper, and an electroformed film was formed and then stripped. Thus, son stampers having the same patterns of protrusions and recesses as those in the father stamper were obtained.

The son stamper was subjected to the ultrasonic washing process for 5 minutes with acetone. Then the son stamper was immersed for 30 minutes or more in a solution prepared by diluting with ethanol to 2% fluoroalkylsilane (CF₃(CF₂)₇CH₂CH₂Si(OMe)₃) that is a silane coupling agent containing chlorine-series fluorinated resin serving as a fluorine-based release agent [trade name TSL8233 available from GE Toshiba silicone Co., Ltd.]. After the solution was blown with a blower, annealing was carried out in a nitrogen atmosphere at 120° C. for 1 hour.

A resist prepared by S1818 (trade name, available from Rhome and hearth Electronics Material Co., Ltd) diluted by 5 times with propylene glycol monomethyl ether acetate (PGMEA) was coated on a 1.8-inch disk substrate of glass with a spin coater. The thickness of the resist was about 100 nm. The patterns of the son stamper were transferred to the resist by pressing the son stamper to the resist at 450 bars for 60 seconds. Then, the stamper was stripped with vacuum tweezers. The pattern had been transferred to the resist film, and then the protrusions and recesses on the surface thereof were cured by UV irradiation for 5 seconds. Then, it was annealed at 160° C. for 30 minutes, and the whole resist film was cross-linked.

In order to remove the resist residue from the recesses on the disk substrate, RIE process was applied using oxygen gas. Then, RIE process using CF₄ gas to etch the glass substrate was applied. At the time of this etching, the RIE time was selected so as to provide three types of substrates having different depths of recesses. Then, the residual resist was removed by RIE using oxygen gas, and a 1.8-inch glass disk substrate having a planer structure corresponding to either FIG. 1 or 2 was fabricated.

A longitudinal magnetic recording media was formed on the disk substrate. A media with a layer structure of NiAl (20 nm)/CrMo (10 nm)/CoCrPtTaB (15 nm)/C (3 nm) was deposited by sputtering. Carbon (C) was deposited by CVD. At this time, the substrate was heated to 150° C. Then, perfluoropolyether was applied as a lubricant to the media by dipping.

The coercivity of this media was estimated to be 3800 Oe by a vibrating sample magnetometer (VSM).

A magnetic recording apparatus was fabricated using the media. As described above, patterns having five types of track pitches (Tp) of 50 nm, 120 nm, 200 nm, 300 nm, and 400 nm were formed on the same media. There were three types of media with the distance “d” of 5 nm, 10 nm, and 20 nm, respectively. The value of “d” was evaluated with a cross-sectional TEM. The clock of servo signals corresponded to the linear recording density was set to be 1 Mbpi. Conditions for the flying height of 5 nm, 10 nm, or 15 nm was determined in advance for the linear velocities of 2 m/s, 6 m/s, 10 m/s, 11 m/s, and 12 m/s, where four types of sliders were used for the magnetic recording apparatus in a chamber capable of varying the pressure and the slider type and the pressure were adjusted. In addition, an apparatus for read/write tests at zero flying height was fabricated by preparing a slider capable of performing contact operation.

The read element used was a TMR sensor. The width of the shield in the cross-track direction was 75 nm. The protective film on the shield was made of C whose thickness was 3 nm, and the thickness of the protective film of the media was also 3 nm. Therefore, the value of “m” was 6 nm, 11 nm, 16 nm, or 21 nm. The values of d/m in this apparatus are shown in Table 1.

DC demagnetization was carried out on the media by performing erasing operation in which a unidirectional magnetic field was applied from the head. Then, tracking precision was estimated by the tracking operation at arbitrarily selected 100 positions based on ABCD burst signals. The tracking precision was defined as a 3σ value calculated by collecting tracking error signals from servo signals by one round of a track.

As a result of experiments, although all the tracking precisions were within 20% of Tp at the linear velocity of 12 m/s, it was found that the tracking precisions were varied depending on the value of d/m at the linear velocity of 11 m/s. The tracking precisions depend on d/m more strongly than on the linear velocity. The results are shown in Table 2. In this table, “very good” indicates that the tracking precisions were smaller than 10% of Tp at all the linear velocities; “good” indicates that the tracking precisions at all the linear velocities were 10% or more and smaller than 20% of Tp; “no good” indicates that the tracking precisions at all the linear velocities were 20% or more of Tp.

When a magnetic recording apparatus with high precision is necessary, for example, it is preferable that the tracking precision to be smaller than 10% of Tp. For a general-purpose HDD apparatus with intermediate recording density intended to be supplied inexpensively, it is sufficient that the tracking precision is smaller than 20% of Tp. Therefore, in the case where the linear velocity is 11 m/s or less, it is preferable that the d/m be 0.2 or more and 3 or less, more preferably 0.25 or more and 2 or less.

TABLE 1

| h | m | d | | d | | d | |
|---|---|---|---|---|---|---|---|
| (nm) | (nm) | (nm) | d/m | (nm) | d/m | (nm) | d/m |
| 0 | 6 | 5 | 0.83 | 10 | 1.67 | 20 | 3.33 |
| 5 | 11 | 5 | 0.45 | 10 | 0.91 | 20 | 1.82 |
| 10 | 16 | 5 | 0.31 | 10 | 0.63 | 20 | 1.25 |
| 15 | 21 | 5 | 0.24 | 10 | 0.48 | 20 | 0.95 |

TABLE 2

| | d/m | | | | | | | | | | | |
|---|---|---|---|---|---|---|---|---|---|---|---|---|
| | 0.24 | 0.31 | 0.45 | 0.48 | 0.63 | 0.83 | 0.91 | 0.95 | 1.25 | 1.67 | 1.82 | 3.33 |
| Evaluation | Good | Very | Very | Very | Very | Very | Very | Very | Very | Good | Good | No |
| | | good | good | good | good | good | good | good | good | | | good |

After the further investigation of the servo signals for samples having poor tracking precisions, it was found that large amount of noise superimposed on the servo signals making the linearity of the tracking error signals poor, which should preferably be a form of triangular wave. The intensity of the noise was found to be fluctuated even during monitoring. It is deduced that the noise was caused by unstable magnetic domains inside the shield as described above, though it is still unclear. When the d/m is smaller than 0.2, the noise is expected to be small. However, it is not clear because no experiment was carried out for that condition. With respect to a media with Tp of 400 nm, no poor tracking precision was observed at the linear velocities examined.

Next, tracking precisions were investigated for the case where the d/m was 0.24, 0.31, 1.25, 1.82, or 3.33 using a head whose shield width was 180 nm. As a result, results similar to those shown in Table 2 were obtained at the all the linear velocities of 11 m/s or less. Thus, it was found that degradation of the tracking precision did not depend on the shield width so much.

### Example 2

A so-called patterned media having a planar structure shown in FIG. 3 was fabricated in accordance with a method similar to that in Example 1. A glass disk having a diameter of 0.85 inch was used as a substrate. Fabrication process was as follows; an SOG was applied on the substrate by spin-coating, the stamper identical to that in Example 1 was imprinted on the substrate, and then it was baked at 250° C., thereby directly forming patterns. Three types of substrates having different depths of recesses were fabricated by applying RIE using SF₆ to SOG, in which the RIE time was controlled.

A perpendicular magnetic recording film was formed on the substrate by sputtering. A layered structure was as follows: a substrate/FeCoTa soft magnetic underlayer (60 nm)/Ta (5 nm)/Ru (10 nm) /CoCrPt (15 nm)/C (3 nm). Substrate was not heated. Carbon (C) was formed by CVD. After the media was removed from the sputtering chamber, perfluoropolyether was applied as a lubricant to the media by dipping.

The coercivity of this media was estimated to be 4500 Oe by a vibrating sample magnetometer (VSM).

The aforementioned magnetic recording apparatus was fabricated using the media. As in Example 1, patterns having five types of track pitches (Tp) of 50 nm, 120 nm, 200 nm, 300 nm, and 400 nm were formed on the same media. There were three types of media with the distance “d” of 5 nm, 10 nm, and 20 nm, respectively. The value of “d” was evaluated with a cross-sectional TEM. Conditions of the flying height of 5 nm, 10 nm, or 15 nm was obtained in advance for the linear velocities of 2 m/s, 6 m/s, 10 m/s, 11 m/s, and 12 m/s with four types of sliders by placing the magnetic recording apparatus in a chamber capable of varying the pressure, where the slider type and the pressure was adjusted. An apparatus capable of zero flying height read/write test was fabricated by using a slider capable of contact operation.

A current-perpendicular-to-plane (CPP) GMR sensor having NOL for the spacer layer was used as a read element. The width of the shield in the cross-track direction was 75 nm. The protective film on the shield was made of C whose thickness was 3 nm, and the thickness of the protective film of the media was also 3 nm. Therefore, the value of m (41) was 6 nm, 11 nm, 16 nm, or 21 nm. The values of d/m in this apparatus are shown in Table 1, as in Example 1.

DC demagnetization was carried out on the media by performing erasing operation in which a unidirectional magnetic field was applied from the head. Then, the tracking precisions were estimated in the same manner as in Example 1.

As a result of experiments, although all the tracking precisions were within 20% of Tp at the linear velocity of 12 m/s, it was found that the tracking precisions were varied depending on the value of d/m at the linear velocity of 11 m/s. The tracking precisions depend on d/m more strongly than to the linear velocity, and as were in Table 2 similar to those in Example 1. In this table, “very good” indicates that the tracking precisions were smaller than 8% of Tp at all the linear velocities; “good” indicates that the tracking precisions at all the linear velocities were 10% or more and smaller than 20% of Tp; “no good” indicates that the tracking precisions at all the linear velocities were 20% or more of Tp. As in the case of Example 1, when the linear velocity was 11 m/s or less, it was found to be preferable that d/m be 0.2 or more and 3 or less, and more preferably 0.25 or more and 2 or less. This result seems to indicate that the noise generation depends on aforementioned magnetization instability inside the magnetic shield more strongly than the difference in the recording system between longitudinal and perpendicular. With respect to a media with Tp of 400 nm, no poor tracking precision was observed at the linear velocities examined.

A description will be given with respect to a material and layer structure for each layer of the magnetic recording media according to an embodiment of the present invention.

<Substrate>

As a substrate, for example, a glass substrate, an Al-based alloy substrate, a ceramics substrate, a carbon substrate, a Si single crystal substrate and the like can be used. An amorphous glass or a crystallized glass can be used as the glass substrate. The amorphous glass includes a soda lime glass, an aluminosilicate glass or the like. The crystallized glass includes a lithium based crystallized glass or the like. As the ceramics substrate, there can be used a sintered material consisting essentially of aluminum oxide, aluminum nitride, silicon nitride or the like. Fiber-reinforced sintered materials described above or the like can be used. A Si single crystal substrate, a so-called silicon wafer may have an oxide film on its surface. A material, in which a NiP layer is formed on a surface of the above metal substrate or non-metal substrate by plating or sputtering, can be used.

<Underlayer>

An underlayer is used for controlling the crystallinity and grain size of a magnetic recording layer and improving the adhesion. An underlayer material used for current magnetic recording media can be used. An underlayer may be composed of a plurality of layers in order to efficiently achieve the aforementioned purposes. An underlayer may be made of a metal or a dielectric or a mixture thereof. The surface of the underlayer may be modified by ion irradiation or gas exposure and the like.

The underlayer may be a magnetic layer. In particular, in the case where a magnetic recording layer is made of a perpendicular magnetic film, a so-called perpendicular double-layered media, in which a soft magnetic underlayer (SUL) with high permeability and a perpendicular magnetic recording layer are stacked, can be used. The soft magnetic underlayer of the perpendicular double-layered media passes a recording magnetic field from a recording magnetic pole. This underlayer is provided to return the recording magnetic field to a return yoke allocated in the vicinity of the recording magnetic pole. That is, the soft magnetic underlayer shares a part of the function of the write head and improves recording efficiency.

A material having high permeability including at least one kind of Fe, Ni, and Co is used as the soft magnetic underlayer. Such materials include: a FeCo based alloy such as FeCo or FeCoV; a FeNi based alloy such as FeNi, FeNiMo, FeNiCr, or FeNiSi; FeAl based and FeSi based alloys such as FeAl, FeAlSi, FeAlSiCr, or FeAlSiTiRu, or FeAlO; a FeTa based alloy such as FeTa, FeTaC, or FeTaN; and a FeZr based allow such as FeZrN.

For the soft magnetic underlayer, there can be used a fine crystalline structure such as FeAlO, FeMgO, FeTaN, and FeZrN containing 60 at % of Fe, or a granular structure, in which fine crystalline particles of above mentioned materials are dispersed in a matrix.

As another material for the soft magnetic underlayer, there can be used a Co alloy containing Co and at least one kind of Zr, Hf, Nb, Ta, Ti, and Y. Preferably, 80 at % or more of Co is contained. When such a Co alloy film is deposited by sputtering process, an amorphous layer is easily formed. The amorphous soft magnetic material shows very excellent soft magnetic property because of the absence of crystalline magnetic anisotropy, crystalline defect, or grain boundary. In addition, low media noise can be achieved by using the amorphous soft magnetic material. The preferred amorphous soft magnetic material can include, for example, CoZr, CoZrNb, and CoZrTa based alloys or the like.

Under the soft magnetic underlayer, an underlayer may further be provided for the purpose of improvement of crystalline property of the soft magnetic underlayer or for the purpose of improvement of adhesion to a substrate. As an underlayer material, there can be used Ti, Ta, W, Cr, Pt, or an alloy including these elements or an oxide or a nitride of these elements.

An intermediate layer made of a non-magnetic material may be provided between the soft magnetic underlayer and the perpendicular magnetic recording layer. The roles of the intermediate layer are to suppress an exchange coupling interaction between the soft magnetic underlayer and the recording layer and to control crystallinity of the recording layer. As a material for the intermediate layer, there can be used Ru, Pt, Pd, W, Ti, Ta, Cr, Si, or an alloy including these elements or an oxide or a nitride of these elements.

For the purpose of preventing spike noise, a soft magnetic underlayer consists of a plurality of layers, in which Ru having thickness of 0.5 nm to 1.5 nm is sandwiched so as to generate anti-ferromagnetic exchange coupling interaction. A soft magnetic layer may be exchanged coupled with a pinning layer made of a hard magnetic layer having in-plane anisotropy such as CoCrPt, SmCo, and FePt or an antiferromagnetic material such as IrMn or PtMn. In these exchange coupled cases, in order to control the exchange coupling force, magnetic layers, for example, Co, or non-magnetic layers, for example, Pt may be stacked on and under the Ru layer.

<Magnetic Recording Layer>

As a magnetic recording layer, a perpendicular magnetic film, in which an easy axis of magnetization is oriented in the perpendicular direction to the media, or an in-plane magnetic film, in which an easy axis of magnetization is oriented in the in-plane direction, can be used. Large magnetic anisotropy energy can be preferably obtained in the case where the magnetic recording layer is made of an alloy consisting essentially of Co, for example, a CoPt alloy. The magnetic recording layer may be made of a material including an oxide. As this oxide, it is preferred to use a Co oxide, a silicon oxide, a titanium oxide, or an oxide of metals constituting the magnetic recording layer.

The magnetic recording layer may be a so-called granular media in which magnetic grains (crystalline grains having magnetic property) are dispersed in the layer. In the case of a discrete track media, the linear recording density seems to be determined by a similar mechanism to that of the conventional media. Thus, it is preferable to use a granular media which is known to improve linear recording density in the conventional media. In the patterned media shown in FIG. 3, linear recording density is determined depending on processing precision, and thus, a magnetic film having a non-granular fine structure may be used.

The magnetic recording layer can contain one or more kinds of elements selected from B, Ta, Mo, Cu, Nd, W, Nb, Sm, Tb, Ru, and Re, in addition to Co, Cr, Pt, and an oxide thereof. These elements are effective to achieve read/write characteristics and/or thermal stability suitable to high density recording since they have functions of reducing the magnetic grain size and improving the crystallinity and orientation of the magnetic grain. A so-called magnetic artificial lattice obtained by laminating Co and noble metal (such as Pt and/or Pd) for many times may be used as a magnetic recording layer. An ordered alloy of magnetic element (Fe and/or Co) and noble metal (Pt and/or Pd) can also be used.

The magnetic recording layer may have a multilayered structure. High density recording can be achieved by using a stacked magnetic recording layer made of two or more magnetic layers each having different magnetic characteristics. The magnetic recording layer may be a stacked layer structure including a plurality of magnetic layers and a plurality of non-magnetic layers. For example, in the case of a longitudinal media, it is known that a Ru layer interposed between a plurality of magnetic layers induces anti-ferromagnetic exchange coupling and improve linear recording density. Therefore, this technique may be used for the present invention.

The thickness of the magnetic recording layer is preferably 2 nm to 60 nm, and more preferably 5 nm to 30 nm. Within this range, a magnetic recording/reproducing apparatus suitable to high recording density can be obtained. If the thickness of the magnetic recording layer is less than 2 nm, a reproduction output becomes small and increases a noise. If the thickness of the magnetic recording layer exceeds 60 nm, a reproduction output becomes large and distorts a signal waveform.

It is preferable that the coercivity of the magnetic recording layer be 237000 A/m (3000 Oe) or more. If the coercivity is less than 237000 A/m (3000 Oe), there is a tendency that thermal stability deteriorates.

<Protective Layer>

A protective layer has a function of preventing corrosion of a magnetic recording layer and of preventing damage on the media surface when a magnetic head comes into contact with the media. A material for the protective layer can include a material containing C, Si—N, Zr—O, or Si—N. It is preferable that the thickness of the protective layer be between 0.5 nm to 10 nm. When the thickness of the protective layer is within the above range, a distance between the head and the media can be reduced. Thus, this range is suitable to high density recording.

<Lubricating Layer>

As a lubricating agent, there can be used perfluoropolyether, a fluorinated alcohol, a fluorinated carboxylic acid and the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording apparatus comprising:
a magnetic recording media comprising: a substrate on which patterns of protrusions and recesses corresponding to a servo zone and patterns of protrusions and recesses corresponding to a data zone are formed, and a magnetic layer on the substrate;
a spindle motor which rotates the magnetic recording media; and
a read/write head mounted on a slider to be positioned in a state of flying over the magnetic recording media, the read/write head including a pair of magnetic shields and a giant magnetoresistive element sandwiched between the magnetic shields,
wherein a track pitch in the data zone of the magnetic recording media is 20 nm or more and 300 nm or less, a relative linear velocity between the read/write head and the magnetic recording media is 11 m/s or less, and, when a distance from the magnetic shield of the read/write head to the magnetic layer on the protrusions of the magnetic recording media is defined as “m” and a distance between the magnetic layer on the protrusions and that on the recesses in the servo zone of the magnetic recording media is defined as “d”, a ratio of d/m is 0.2 or more and 3 or less.

2. The magnetic recording apparatus according to claim 1, wherein the value of d/m is 0.25 or more and 2 or less.

3. The magnetic recording apparatus according to claim 1, wherein the magnetic recording media is a longitudinal magnetic recording media.

4. The magnetic recording apparatus according to claim 1, wherein the magnetic recording media is a perpendicular magnetic recording media.
